(19) United States
(12) Patent Application Publication
(10) Pub. No.: US 2015/0330910 A1
(43) Pub. Date: Nov. 19, 2015

(54) Cosmetic Evaluation Box for Used Electronics

(71) Applicants: Tu Nguyen, Fremont, CA (US); Tien Trinh, Ho Chi Minh City (VN)

(72) Inventors: Tu Nguyen, Fremont, CA (US); Tien Trinh, Ho Chi Minh City (VN)

(73) Assignee: GDT, INC., Fremont, CA (US)

(21) Appl. No.: 14/690,449

(22) Filed: Apr. 19, 2015

Related U.S. Application Data
(60) Provisional application No. 61/984,666, filed on Apr. 25, 2014.
(60) Provisional application No. 62/027,096, filed on Jul. 21, 2014.

(51) Int. Cl. G01N 21/88

(52) U.S. Cl. CPC G01N 21/8851; G01N 21/8806; G01N 2021/8841; G01N 2021/8854

(57) ABSTRACT

A cosmetic testing device for electronic devices that uses the electronic device's own camera to take photographs of the electronic device in order to determine its cosmetic condition.

### CROSS-REFERENCE TO RELATED APPLICATIONS

The present application takes priority from Provisional App. No. 61/984,666, filed Apr. 25, 2014, and Provisional App. No. 62/027,096, filed Jul. 21, 2014, which are herein incorporated by reference.

### BACKGROUND

Smartphones and other small electronic devices evolve rapidly, and thus are frequently upgraded by consumers. As a result, many consumers have one or more used electronic devices that they no longer need. Reselling those devices is often a hassle that does not justify the time or the expense of doing so.

In order to determine the value of a used electronic device, its functional capacity and its cosmetic condition need to be evaluated. While evaluating a device's functional capacity usually only requires some simple electronics, evaluating the device's cosmetic condition requires either a human eye (and humans are often biased and inconsistent) or expensive and complex camera systems. In situations where a used electronic device is being repurchased automatically, at a kiosk, for example, the only option being used at present is expensive and complex camera systems. Such camera systems are used to take photographs of the electronic device, and the photographs are then analyzed to determine the number, size, and location of any cosmetic imperfections of the electronic device. This data is then used to determine a cosmetic score for the electronic device and to provide an objective measure of its cosmetic condition.

While it is possible to use a camera system to evaluate an electronic device, it adds a lot of expense and complexity to the evaluation machine. Camera systems are not only expensive, they break and require repair; they require periodic maintenance; and the software needed to operate them is also complex and prone to breaking.

Most electronic devices of today, such as smartphones and tablets, typically comprise one or more cameras. The cameras on such devices are often quite sophisticated and the device comprises all the software needed to operate the camera. Due to this fact, it is desirable to make it possible to use an electronic device's own camera in performing the cosmetic evaluation of the electronic device.

A need therefore exists for a fixture that holds an electronic device in an appropriate position for using the electronic device's own camera or cameras to take photographs of the electronic device, and provides mirrors in the appropriate positions so that the electronic device's own camera or cameras can take photographs of the electronic device.

### SUMMARY OF THE INVENTION

An object of the present invention is to reduce the cost and complexity of cosmetic evaluation devices by utilizing an electronic device's own camera in performing the cosmetic evaluation.

Another object of the present invention is to enable a test of an electronic device's cosmetic condition to be performed easily and cheaply.

For purposes of the present invention, an “electronic device” is a smartphone, tablet, or other small electronic device that comprises at least one camera.

The system of the present invention comprises an enclosure that contains at least one mirror and a device holder. The device holder securely holds an electronic device without obstructing any of its cameras. The mirror or mirrors are positioned in such a way as to reflect a view of the electronic device so that an image of the electronic device may be taken by one of its cameras. The enclosure also contains at least one light source, preferably a light panel of the type used in photography. A processor and memory are used to control the light source, to trigger the electronic device to take photographs, and to retrieve photographs from the electronic device.

The system of the present invention also preferably comprises a connector for connecting to the electronic device. In an embodiment, the connection to the electronic device is wireless.

The device holder preferably comprises a top member and a bottom member, the top member coming in contact with the top of the device and the bottom member coming in contact with the bottom of the device. The inner surfaces of the top member and the bottom member are preferably soft and unable to scratch the device.

The inside surfaces of the enclosure are preferably matte to prevent reflections. In the preferred embodiment, the inside surfaces are white.

The enclosure preferably comprises at least one door, said door closed automatically or manually before the cosmetic test begins.

### LIST OF FIGURES

FIG. 1 shows a diagram of the preferred embodiment of the present invention.

FIG. 2 shows another view of the preferred embodiment of the present invention.

FIG. 3 shows a view of the outside of the enclosure of the preferred embodiment of the present invention.

### DETAILED DESCRIPTION OF THE PREFERRED EMBODIMENT

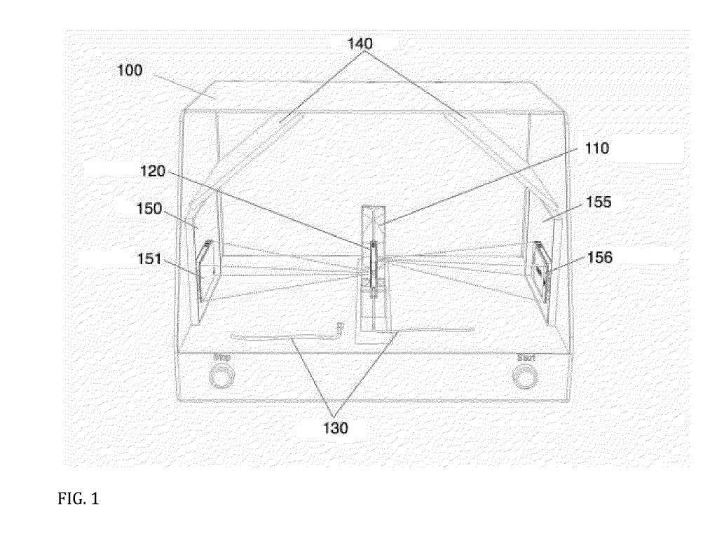

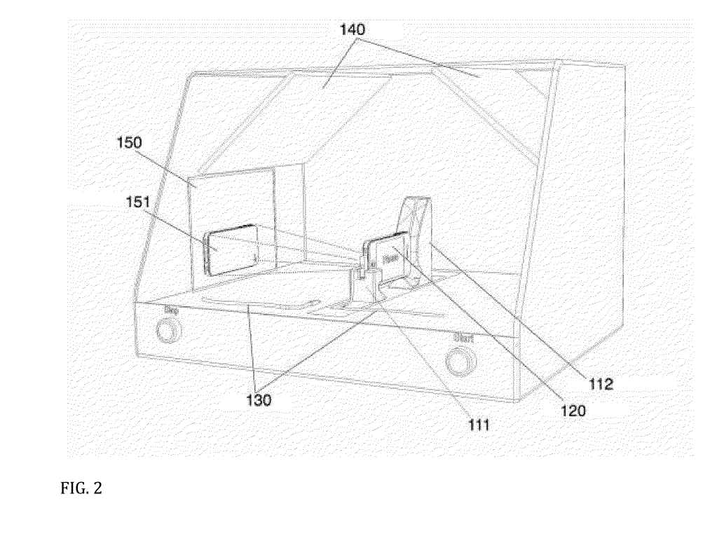

FIGS. 1 and 2 show the preferred embodiment of the present invention. It is preferably an enclosure 100 with a holder module 110 located approximately at the midpoint of the container. Holder module 110 is preferably sized and shaped in such a way as to hold a smartphone or other small electronic device 120 without obstructing the electronic device's cameras. In an embodiment, different-size holder modules may be used depending on what electronic device is tested; the enclosure 100 may have mounting hardware that allows different holder modules to be attached.

The holder module preferably comprises a front clip 111 and a rear clip 112, as shown in FIG. 2. The front clip and the rear clip are preferably flexible or soft in a way that enables the electronic device to be securely held between them. In the preferred embodiment, the inner surface of the front clip and the rear clip are also lined with a soft fabric that does not damage the finish of the electronic device. The front clip 111 preferably has a cutout that accommodates a connector, as shown in the Figure. Since different electronic devices have connectors of different shape, the cutout is preferably large enough to accommodate the largest such connector.

A cable 130 is used to connect to the electronic device 120. The system of the present invention may have several cables available with different connectors, so that a user may choose the appropriate cable for connecting to the electronic device. The cable is preferably used to connect the electronic device to a processor and memory (not shown), said processor and memory used to trigger the electronic device to take photographs, receive photographs from the electronic device, perform a cosmetic analysis on the photographs, and use the results of the cosmetic analysis to develop a cosmetic score for the electronic device. The processor also controls any lighting within the enclosure during the evaluation process.

In another embodiment, a wireless connection rather than a cable is used to connect the processor to the electronic device. Such a wireless connection may be wi-fi, cellular, Bluetooth, or any other wireless connection available for the particular electronic device.

Light sources 140 are used to provide adequate lighting for any photos taken within the enclosure. In the preferred embodiment, the light sources are light panels such as typically used in photography, to provide uniform lighting for the electronic device. The light sources preferably emit white light; however, light of any other color may also be used. The light sources are positioned in such a way as to emit light onto the electronic device for an adequate photograph to be taken. In the preferred embodiment, as shown in FIGS. 1 and 2, the light sources 140 are located above the device.

Mirrors 150 and 155 are used to reflect the electronic device in such a way that a photograph of the electronic device may be taken with the electronic device's own camera. In the preferred embodiment, as shown in the Figure, two mirrors are used, one on each side of the electronic device. Mirror 150 is used to reflect an image of the electronic device 151 for the rear-facing camera to take a photograph of the device; mirror 155 is used to reflect an image of the electronic device 156 for the front-facing camera to take a photograph of the device.

The mirrors are preferably positioned in such a way as to “place” the image of the electronic device at the closest focal distance from the device's camera that is taking the photograph. Since every device's camera is slightly different, the mirrors may be positioned at the largest such distance, so that most of the devices placed in the enclosure will be accommodated.

The preferred embodiment, as shown, only enables two photos to be taken—a photo of the front and the rear sides of the electronic device. In other embodiments, multiple mirrors may be used to reflect other sides of the electronic device in such a way as to enable either the front-facing or the rear-facing camera of the electronic device to take photos of the left side, right side, top side, or bottom side of the electronic device. In an embodiment, mirrors may be moved or repositioned by the user in such a way as to reflect a particular side of the device. Mirrors may also be moved automatically by the system of the present invention to be in the proper position for photos to be taken of a particular side of the device.

On most electronic devices such as smartphones and tablets, the screen of the device shows an image of what is “seen” by the camera. When the front-facing camera on an electronic device is used to take a photo of the device itself in the mirror, the screen of the electronic device shows a recursive image of the device taking a picture of itself. This image may interfere with the cosmetic analysis of the electronic device, as scratches and other imperfections may be obscured. In an embodiment, the processor disables the screen on the electronic device while the front-facing camera is used to take a photograph of the device. The screen of the electronic device may be turned off altogether, or may show a solid color such as white or blue, to highlight any imperfections on the device's screen.

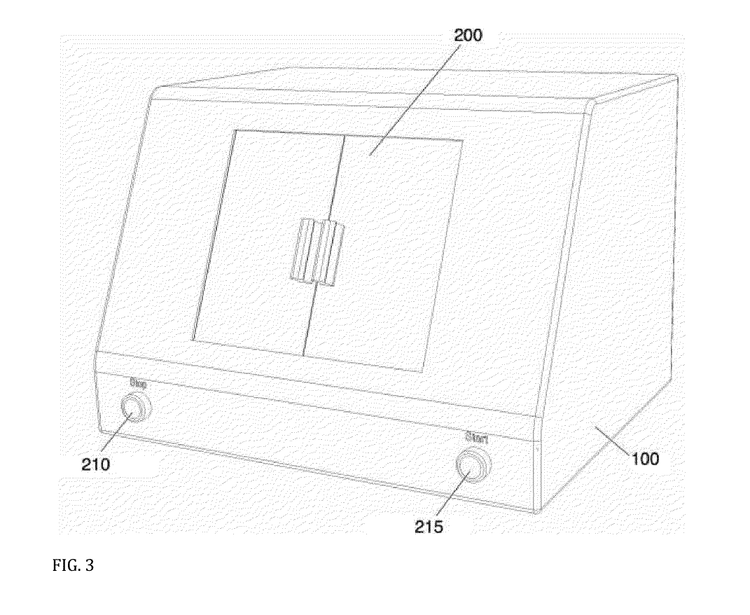

The user interface for the system of the present invention is preferably a simple start button 210 and stop button 215, as shown in FIG. 3. The start button triggers the system to connect to an electronic device placed in the holder and to perform the testing process. The stop button triggers the system to stop the test at any point during the testing process. Other embodiments may comprise other types of user interface, such as touchscreens, knobs, switches, and any other user interface known in the art.

FIG. 3 shows an outer view of the system of the present invention. Doors 200 are sliding doors that close prior to the start of the testing process. This ensures that no external light gets into the testing area and allows the lighting to be more controlled for better photographs. The doors may be closed manually by the operator or may close automatically when the start button is pushed. The doors may comprise light-blocking foam or other features that prevent any light from getting inside the enclosure while the doors are closed.

The inner surface of the enclosure may be painted or finished in such a way as to minimize unwanted light reflections and to improve the photographs taken of the electronic device. In the preferred embodiment, the inner surface is matte white.

Once the photographs of the electronic device are taken, they may be transmitted to the processor for analysis. Any analysis method is compatible with the system of the present invention. In the preferred embodiment, the processor modifies the photographs to improve contrast or some other visual parameter in such a way as to make imperfections more visible. The photos are then compared to reference photos of an undamaged device of the same type. The markings on the photo that do not exist in the reference photo are counted and their length is measured. In an embodiment, the markings are also categorized into different categories such as “cracks”, “scratches”, “scuffs”, and so on.

Exemplary embodiments have been described above. It will be understood that the invention encompasses other embodiments and that the only limitations on the scope of the present invention are expressed in the appended claims.

1. A cosmetic testing fixture for an electronic device, said electronic device comprising at least one camera, said cosmetic testing fixture comprising:
an enclosure;
a user interface;
a device holder, said device holder mounted inside the enclosure, said device holder capable of securely holding an electronic device without obstructing any of its cameras;
at least one mirror, said mirror located in such a way as to reflect an image of the electronic device so that it is within the view of the at least one camera;
at least one light fixture, said light fixture located within the enclosure in such a way as to provide adequate lighting for the at least one camera to take a photograph of the image of the electronic device;
a device connector, said device connector connected to the electronic device;
a processor, said processor configured to perform the following functions:
identify the electronic device;
trigger the electronic device to take a photograph using the at least one camera.

2. The cosmetic testing fixture of claim 1, where the inner surface of the enclosure is matte.

3. The cosmetic testing fixture of claim 1, comprising a first mirror, said first mirror being positioned in such a way as to reflect an image of the electronic device into a front-facing camera of the electronic device when the electronic device is in the device holder, and a second mirror, said second mirror being positioned in such a way as to reflect an image of the electronic device into a rear-facing camera of the electronic device when the electronic device is in the device holder.

4. The cosmetic testing fixture of claim 3, further comprising a third mirror, said third mirror being positioned in such a way as to reflect an image of the left side, right side, top side, or bottom side of the electronic device into at least one camera of the electronic device.

5. The cosmetic testing fixture of claim 4, wherein at least one of the first mirror, second mirror, and third mirror may be repositioned.

6. The cosmetic testing fixture of claim 5, wherein the repositioning is automatic.

7. The cosmetic testing fixture of claim 1, wherein the at least one mirror is at a distance from the electronic device that is equal to or greater than the minimal focal distance for the camera of the electronic device.

8. The cosmetic testing fixture of claim 1, wherein the enclosure comprises at least one door.

9. The cosmetic testing fixture of claim 1, wherein the device holder comprises:
a top member, said top member in contact with the top of the electronic device when the electronic device is in the device holder;
a bottom member, said bottom member in contact with the bottom of the electronic device;
the top member and the bottom member being situated in such a way as to provide sufficient pressure onto the top and bottom of the electronic device to securely hold it in the device holder.

10. The cosmetic testing fixture of claim 9, wherein at least one of the top member and the bottom member comprises a soft fabric on the surface that contacts the electronic device.

11. The cosmetic testing fixture of claim 1, wherein the user interface comprises:
a start button;
a stop button.

12. The cosmetic testing fixture of claim 1, wherein the at least one light fixture is a light panel.
